(19) United States
(12) Patent Application Publication
(10) Pub. No.: US 2008/0090128 A1
(43) Pub. Date: Apr. 17, 2008

(54) Electrode Catalyst for Fuel Cell and Fuel Cell

(75) Inventors: Katsushi Saito, Aichi (JP); Hiroaki Takahashi, Aichi (JP); Hideyasu Kawai, Aichi (JP); Toshiharu Tabata, Shizuoka (JP); Takahiro Nagata, Shizuoka (JP); Tomoaki Terada, Shizuoka (JP); Yosuke Horiuchi, Shizuoka (JP); Norihiko Setoyama, Aichi (JP); Takahiko Asaoka, Aichi (JP)

Correspondence Address: OLIFF & BERRIDGE, PLC, P.O. BOX 320850, ALEXANDRIA, VA, 22320-4850, US

(73) Assignees: TOYOTA JIDOSHA KABUSHIKI KAISHA, TOYOTA-SHI (JP); CATALER CORPORATION, KAKEGAWA-SHI (JP)

(21) Appl. No.: 11/793,309

(22) PCT Filed: Dec. 22, 2005
(86) PCT No.: PCT/JP05/24171

§ 371 Date: Nov. 1, 2007

(30) Foreign Application Priority Data
Dec. 24, 2004 (JP) 2004-374194

(51) Int. Cl. B01J 23/42; H01M 8/10

(52) U.S. Cl. 429/30; 502/101; 502/326; 502/331; 502/339

(57) ABSTRACT

A flooding phenomenon is suppressed in a high current density loading region so as to attempt the improvement of cell performance of fuel cells. An electrode catalyst for fuel cells, in which a catalyst comprising an alloy catalyst composed of a noble metal and one or more transition metals and having surface characteristics such that it shows a pH value in water of 6.0 or more is supported on conductive carriers, and a fuel cell using such electrode catalyst for fuel cells, are provided.

### TECHNICAL FIELD

The present invention relates to an electrode for fuel cells having a suppressing effect on flooding in a high current density loading region and a fuel cell with excellent durability.

### BACKGROUND ART

In a fuel cell in which a solid polymer electrolyte membrane having hydrogen ion-selective permeability was made to adhere in an air-tight manner to an electrode catalyst layer having catalyst-supporting carriers laminated thereon, and in which the solid polymer electrolyte membrane with the electrode catalyst layer was sandwiched by a pair of electrodes having gas diffusibility, electrode reactions represented by the equations below proceed in both electrodes (anode and cathode) that sandwich the solid polymer electrolyte membrane in accordance with their polarity so that electric energy is obtained.
Anode (hydrogen pole): H₂→2H⁺+2e⁻ (1)
Cathode (oxygen pole): 2H⁺+2e⁻+(½)O₂→H₂O (2)

When humidified hydrogen or fuel gas containing hydrogen arrives at a catalyst layer by passing through a gas diffusion layer, or a current collector, of the anode, the reaction of Formula (1) occurs. Hydrogen ions, “H⁺,” generated at the anode by the reaction of Formula (1), permeate (diffuse) with water molecules through a solid polymer electrolyte membrane, and then move toward the cathode. Simultaneously, electrons, “e⁻,” generated at the anode, pass through the catalyst layer, the gas diffusion layer (current collector), and then a load connected to the anode and the cathode via an external circuit so as to move toward the cathode.

Meanwhile, at the cathode, oxidant gas containing humidified oxygen arrives at a catalyst layer by passing through a gas diffusion layer, or a current collector, of the cathode. Then, oxygen receives electrons that have passed through the external circuit, the gas diffusion layer (current collector), and then the catalyst layer so as to be reduced by the reaction of Formula (2). Further, the reduced oxygen binds with protons, “H⁺,” that have moved by passing through the electrolyte membrane from the anode so that water is generated. Some of the generated water enters the electrolyte membrane due to a concentration gradient, diffuses and moves toward a fuel electrode, and then partially evaporates to diffuse through a catalyst layer and a gas diffusion layer to arrive at a gas channel so as to be discharged with unreacted oxidant gas.

Likewise, at both cathode and anode sides, a flooding phenomenon occurs due to aggregation with water, resulting in the degradation of power generation performance.

However, downsizing a fuel cell system essentially requires high output in a high current density loading region. References such as JP Patent Publication (Kokai) No. 2003-24798 A disclose performance examinations in a high current density loading region using binary or ternary alloy catalysts made up of platinum and transition metal elements.

To improve the catalyst performance of a platinum catalyst that has been conventionally used for fuel cells or the like, second and third metal salts are added to the catalyst, the resultant is heat-treated to result in a platinum alloy catalyst, and the platinum alloy catalyst is molded, such that the thus obtained catalyst may then be used in electrodes. By doing so, it has become possible to enhance initial characteristics in terms of electrode performance. However, voltage drop suppression during life tests has been limited to approximately 15 mV/1000 hours. Thus, the desired level of 5 mV/1000 hours cannot be achieved, which has been problematic. Based on various studies of such problem, it has been thought that some amounts of the second and third metals are not alloyed with platinum, so that these metals, which are found in the catalyst separately or in the form of an alloy of such second and third metals, experience changes in their characteristics during long term use, resulting in voltage drop. Thus, development of a method for coping with this problem has been desired.

For the purpose of improving the performance of a platinum alloy catalyst for fuel cells and preventing voltage drop during long term use, JP Patent Publication (Kokai) No. 6-246160 A (1994) discloses a method for producing a platinum alloy catalyst, wherein second and third metal salts are added to a platinum catalyst, the resultant is heat-treated to result in a platinum alloy catalyst, and the platinum alloy catalyst is subjected to acid treatment for dissolution and extraction of platinum and non-alloyed second and third metals, followed by washing and heat-drying in inactive gas.

### DISCLOSURE OF THE INVENTION

Regarding binary or ternary alloy catalysts disclosed in JP Patent Publication (Kokai) No. 2003-24798 A and the like, performance degradation caused by an increase in the amount of generated water (flooding phenomenon) due to high activation has been problematic.

In addition, compared with a platinum catalyst that has been used as a cathode catalyst for fuel cells, a catalyst obtained by adding different metals to platinum can achieve high performance. However, addition of metals other than platinum causes deterioration of electrolyte membranes and the like due to elution of metals added, resulting in decrease in cell voltage during long-hour operation. On the other hand, the method disclosed in JP Patent Publication (Kokai) No. 6-246160 A (1994) relates to an acid wash method for removing metals added that have not been alloyed and can act as a cause of elution. Examples of acid used in the method include hydrochloric acid, nitric acid, phosphoric acid, sulfuric acid, hydrofluoric acid, and acetic acid. However, when these acids are used for an acid wash at 80° C. to 100° C., functional groups are added to the surface of carbon, resulting in a hydrophilic catalyst. Thus, upon operation of fuel cells having a membrane electrode assembly (MEA) comprising such catalyst, gaseous diffusibility deteriorates due to the presence of water in a current density region (1 A/cm² or more), where a large amount of water is generated, so that cell voltage sharply declines or becomes unstable.

The object of the present invention is to solve the above problem and to provide a novel electrode catalyst for suppressing the flooding phenomenon in high current density loading region of a fuel cell and realizing stable long-term operation.

Inventors of the present invention found that the above problems can be overcome by using alloy catalysts supported on conductive carriers and identifying surface characteristics. This has led to the completion of the present invention.

That is, in a first aspect, the present invention is an invention of an electrode catalyst for fuel cells comprising an alloy composed of a noble metal (1) and one or more transition metals (2) that is supported on conductive carriers and showing a pH value in water of 6.0 or more. In the present invention, “a pH value in water of 6.0” indicates a pH value in water of 6.0 or more after agitating 0.5 g of the catalyst in 20 g of pure water for an hour.

It is considered that the quantity of surface functional groups and the hydrophilicity/hydrophobicity of an alloy catalyst supported on conductive carriers of the present invention influence catalytic activities or the like. For instance, the catalyst of the present invention contains a larger quantity of basic surface functional groups than conventional catalysts, though the quantities of acidic surface functional groups such as COOH, COO—, and OH contained by both are almost equivalent. Therefore, the catalyst as a whole becomes hydrophobic since the basic functional groups show hydrophobicity, resulting in a pH value in water of 6.0 or more.

Either the cathode side or the anode side of the electrode catalyst for fuel cells of the present invention is usable. By using an alloy catalyst comprising platinum and transition metals and identifying the pH value in water or the quantity of surface functional groups of the catalyst, performance deterioration in a high current density loading region due to flooding can be prevented so that stable long-term fuel cell operation can be realized.

Preferably, examples of a catalyst alloy used for the electrode catalyst for fuel cells of the present invention include a catalyst alloy comprising platinum that serves as the aforementioned noble metal (1) and one or more metals that serve as the aforementioned transition metals (2) selected from the group consisting of iron, cobalt, nickel, chromium, copper, manganese, titanium, zirconium, vanadium, and zinc. Of these, a platinum-cobalt alloy is particularly preferable.

To obtain a cell voltage superior to that of conventional electrode catalysts for fuel cells, the composition ratio (molar ratio) of an alloy composed of the noble metal (1) and the transition metals (2) is preferably determined to be within a range such that (1):(2) is 2:1 to 9:1, and more preferably, 3:1 to 6:1. The higher the ratio of such alloyed metal, the more elution thereof, and the smaller the ratio of such alloyed metal, the lower the cell performance.

Further, preferably, the particle diameter of particles of the alloy catalyst of the electrode catalyst for fuel cells of the present invention is 5 nm or less.

In a second aspect, the present invention is an invention of an electrode for solid polymer fuel cells using the aforementioned electrode catalyst for fuel cells, which is an electrode for fuel cells having a catalyst layer comprising the electrode catalyst for fuel cells and a polymer electrolyte. The electrode for fuel cells of the present invention can be used as either the cathode or the anode.

In a third aspect, the present invention is an invention of a solid polymer fuel cell using the aforementioned electrode for fuel cells, which is a solid polymer fuel cell having an anode, a cathode, and a polymer electrolyte membrane disposed between the anode and the cathode and comprising the electrode for fuel cells that serves as the cathode and/or the anode.

In a fourth aspect, the present invention is an invention of a method for producing an electrode catalyst for fuel cells having ternary catalyst particles supported thereon. The method comprises: a step of supporting a noble metal (1) and one or more transition metals (2) on conductive carriers, and the metal (1) and (2) are alloyed, a step of washing impurities that have not been alloyed by acid treatment, and a step of performing dry reduction using reducing gas or wet reduction using a reducing agent; or a step of supporting a noble metal (1) and one or more transition metals (2) on conductive carriers, and the metal (1) and (2) are alloyed, and a step of washing impurities that have not been alloyed by acid treatment using a reducing acid. By means of the steps described above, an electrode catalyst for fuel cells, in which an alloy comprising a noble metal (1) and one or more transition metals (2) is supported on conductive carriers, and which shows a pH value in water of 6.0 or more, can be produced.

Herein, preferably, examples of the reducing gas include hydrogen gas, examples of the reducing agents include one or more agents selected from the group consisting of alcohols, formic acid, acetic acid, lactic acid, oxalic acid, hydrazine, and sodium borohydride, and examples of the reducing acids include one or more acids selected from the group consisting of formic acid, acetic acid, lactic acid, and oxalic acid.

An electrode catalyst comprising an alloy catalyst composed of a noble metal (1) and one or more transition metals (2) and having surface characteristics such that it shows a pH value in water of 6.0 or more becomes hydrophobic. Thus, when such catalyst is formed into an MEA, water-drainage performance is improved (flooding phenomenon can be suppressed). Thus, voltage drop in a high current region where the amount of water generated is large can be suppressed. In addition, the improved cell voltage in a high current density loading region results in improved high output, so that fuel cells can be downsized.

### BRIEF DESCRIPTION OF THE DRAWINGS

FIG. 1 shows a comparison of current-voltage characteristics among a single cell prepared with a catalyst of Example 1, a single cell prepared with a catalyst of Example 2, and a single cell prepared with a catalyst of the Comparative Example.

### BEST MODE FOR CARRYING OUT THE INVENTION

Fuel cells, to which the present invention is applied, can employ, but are not limited to, conventionally known components in terms of the structures, materials, physical properties, and functions thereof. Preferred examples of conductive carriers, for example, include one or more carbon materials selected from among carbon black, graphite, activated carbon, and carbon nanotube. Of them, carbon material having a specific surface area of 100 to 2000 (m²/g) comprising carbon black having conductivity and durability or carbon black such as acetylene black is preferable.

For an alloyed metal comprising a noble metal, particularly for a platinum alloyed metal, it is preferable to select one or more transition metallic elements such as Fe, Co, Ni, Cr, Cu, or Mn. Preferably, the aforementioned metals for a catalyst are subjected to alloy treatment in hydrogen, nitrogen, or an inactive gas such as argon at 400 to 1000° C. for 0.5 to 10 hours. The catalyst particle can be controlled depending on atmosphere, temperature, and the length of the treatment time. Preferably, the catalyst particle size is controlled so as to be 5 nm or less.

In addition, any solid polymer electrolyte that functions as an electrolyte in a solid polymer fuel cell can be used. Particularly, a perfluorosulfonic acid polymer is preferable. Preferably, examples thereof include, but are not limited to, Nafion (DuPont), Flemion (Asahi Glass Co., Ltd.), and Aciplex (Asahi Kasei Corporation).

A single cell for the fuel cell of the present invention comprises an anode and a cathode that sandwich a polymer electrolyte membrane, a conductive separator plate on the anode side having a gas channel supplying fuel gas to the anode, and a conductive separator plate on the cathode side having a gas channel supplying an oxidant gas to the cathode.

### EXAMPLES

Examples and Comparative Examples of the present invention will be hereafter described.

### Example 1

Commercially available carbon black powder having a specific surface area of approximately 1000 m²/g (50g) was added to 0.5 liter of pure water and allowed to disperse therein. To the resulting dispersion solution, a chloroplatinic acid solution containing 5.0 g of platinum was added dropwise and allowed to blend sufficiently with carbon. Then, the solution was neutralized with an ammonia solution, followed by filtration. Next, the resulting cake obtained above was allowed to disperse again uniformly in a liter of pure water. A dispersion solution prepared by dissolving cobalt nitrate comprising 0.5 g of cobalt in 0.1 l of pure water was added dropwise to the solution. The obtained solution was neutralized with an ammonia solution, followed by filtration. The thus obtained cake was vacuum dried at 100° C. for 10 hours. Thereafter, the resultant was subjected to alloy treatment at 600° C. for 6 hours in an argon atmosphere in an electric furnace. The thus obtained catalyst subjected to alloy treatment was determined to be catalyst A.

To remove non-alloyed metals from 10 g of catalyst A, catalyst A was agitated in a litter of a formic acid solution (3 mol/l) and retained in the solution, which had a temperature of 60° C., for an hour, followed by filtration. The thus obtained cake was vacuum dried at 100° C. for 10 hours, such that catalyst powder (I) was obtained.

To determine catalyst particle size, the obtained catalyst powder was subjected to XRD measurement. The particle size was found to be 3.6 nm as a result of calculation of average particle size based on the peak position and half value thickness of Pt (111). The quantity of basic surface functional groups of the catalyst was determined by neutralization titration. Accordingly, the quantity of basic surface functional groups was found to be 68 meq.

The catalyst (0.5 g) was sufficiently pulverized in a mortar and agitated in 20 g of pure water for 1 hour, followed by determination using a pH meter (F-2 type, Horiba). The pH value of the catalyst in water was found to be 6.6 as a result of the determination. The specific surface area of the catalyst was determined using a specific surface area analyzer (FlowSorb 2300, Shimadzu). The catalyst (0.05 g) was subjected to a pretreatment of drying at 100° C. for 0.5 hour and degasification at 250° C. for 0.5 hour, followed by determination using a 30% nitrogen-70% helium mixed gas. The specific surface area of the catalyst was found to be 384 m²/g as a result of the determination.

### Example 2

Catalyst A (10 g) was agitated in a litter of a nitric acid solution (3 mol/l) and retained in the solution having a temperature of 90° C. for an hour, followed by filtration. The thus obtained cake was vacuum dried at 100° C. for 10 hours. Thereafter, the resultant was reduced at 100° C. for an hour in a hydrogen atmosphere in an electric furnace, such that catalyst powder (II) was obtained.

As in the case of Example 1, physical properties of the catalyst were determined. The catalyst particle size was found to be 3.7 nm, the quantity of basic surface functional groups was found to be 62 meq, the pH value in water was found to be 6.8, and the specific surface area was found to be 378 m²/g.

### Comparative Example

Catalyst A (10 g) was agitated in a litter of a nitric acid solution (3 mol/l) and retained in the solution, which had a temperature of 90° C., for an hour, followed by filtration. The thus obtained cake was vacuum dried at 100° C. for 10 hours, such that catalyst powder (III) was obtained.

As in the case of Example 1, physical properties of the catalyst were determined. The catalyst particle size was found to be 3.6 nm, the quantity of basic surface functional groups was found to be 41 meq, the pH value in water was found to be 5.0, and the specific surface area was found to be 367 m²/g.

Table 1 below shows a summary of the physical properties of catalyst powders (I) to (III). It is understood that catalyst powders (I) and (II), which were finally subjected to a reduction treatment, contain a small quantity of functional groups of the catalyst, so that they exhibit increased pH values in water and result in a hydrophobic catalyst. In addition, even after carrying out reduction treatment, no difference was found in terms of the particle size or specific surface area, both of which influence catalyst performance.

TABLE 1

| | Example 1 | Example 2 | Comparative |
|---|---|---|---|
| | Catalyst | Catalyst | Example |
| | Powder | Powder | Catalyst Powder |
| | (I) | (II) | (III) |
| Catalyst Particle Size | 3.6 | 3.7 | 3.6 |
| (nm) | | | |
| Basic Surface | 68 | 62 | 41 |
| Functional Group | | | |
| Quantity (meq) | | | |
| pH Value in Water | 6.6 | 6.8 | 5.0 |
| Specific Surface Area | 384 | 378 | 367 |
| (m²/g) | | | |

[Fuel Cell Performance Evaluation]

Single-cell electrodes for solid polymer fuel cells were formed as shown below using the obtained platinum-supporting carbon catalyst powders (I) to (III). The platinum-supporting carbon catalyst powders (I) to (III) were allowed to disperse separately in an organic solvent, and the respective dispersion solutions were applied to a Teflon (trade name) sheet, such that catalyst layers were formed. The amount of platinum catalyst used was 0.4 mg per 1 cm² of each electrode. A pair of electrodes formed with the same platinum-supporting carbon catalyst powder (I), (II), or (III) sandwiched a polymer electrolyte membrane so as to be bonded together by hot pressing. A diffusion layer was disposed on both sides thereof to form single-cell electrodes. Humidified air (1 l/min) that had passed through a bubbler heated at 70° C. was supplied to an electrode on the cathode side of the single cells, and humidified hydrogen (0.5 l/min) that had passed through a bubbler heated at 85° C. was supplied to an electrode on the anode side of the single cells. Then, current-voltage characteristics of the single-cell electrodes were determined. The results are shown in Table 1.

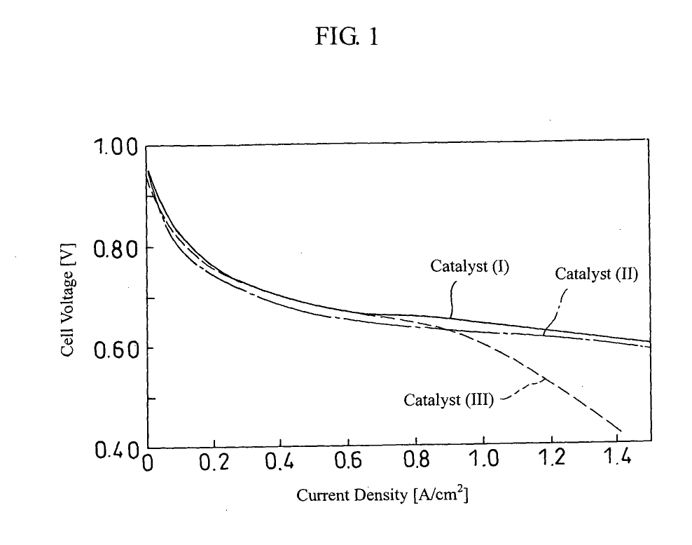

FIG. 1 shows results of current-voltage characteristics, indicating that a high voltage in a high current density region was obtained in the cases of catalyst powders (I) and (II). However, voltage sharply dropped in the region in the case of catalyst powder (III). Accordingly, it has been elucidated that cathode catalysts prepared by the catalyst preparation method suggested in the present invention become hydrophobic after being finally subjected to a reduction treatment, resulting in the obtaining of a high voltage in a high current density region.

### INDUSTRIAL APPLICABILITY

In a fuel cell in which a catalyst comprising an alloy catalyst composed of a noble metal (1) and one or more transition metals (2) and having surface characteristics such that it shows a pH value in water of 6.0 is used, a flooding phenomenon in a high current density loading region can be suppressed so that cell performance can be improved. Therefore, such fuel cells can achieve high performance, and thus apparatuses thereof can be downsized. This contributes to the spread of fuel cells.

1. An electrode catalyst for fuel cells comprising an alloy composed of a noble metal and one or more transition metals selected from the group consisting of iron, cobalt, nickel, chromium, copper, manganese, titanium, zirconium, vanadium, and zinc that is supported on conductive carriers and showing a pH value in water of 6.0 or more after 0.5 g of the catalyst has been agitated in 20 g of pure water for an hour.

2. (canceled)

3. The electrode catalyst for fuel cells according to claim 1, wherein the composition ratio (molar ratio) of an alloy composed of said noble metal and said transition metals is determined to be within a range such that (1):(2) is 2:1 to 9:1.

4. The electrode catalyst for fuel cells according to claim 1, the particle diameter of particles of said catalyst comprising an alloy is 10 nm or less.

5. An electrode for fuel cells having a catalyst layer comprising the electrode catalyst for fuel cells according to claim 1 and a polymer electrolyte.

6. A solid polymer fuel cell having an anode, a cathode, and a polymer electrolyte membrane disposed between the anode and the cathode and comprising the electrode for fuel cells according to claim 5, which serves as the cathode and/or the anode.

7. A method for producing an electrode catalyst for fuel cells comprising a step of alloying a noble metal and one or more transition metals selected from the group consisting of iron, cobalt, nickel, chromium, copper, manganese, titanium, zirconium, vanadium, and zinc while the metals are supported on conductive carriers, a step of washing impurities that have not been alloyed by acid treatment, and a step of performing dry reduction using reducing gas or wet reduction using a reducing agent.

8. A method for producing an electrode catalyst for fuel cells comprising a step of alloying a noble metal and one or more transition metals selected from the group consisting of iron, cobalt, nickel, chromium, copper, manganese, titanium, zirconium, vanadium, and zinc while the metals are supported on conductive carriers, and a step of washing impurities that have not been alloyed by acid treatment using a reducing acid.

9. The method for producing an electrode catalyst for fuel cells according to claim 7, wherein said reducing gas is hydrogen gas.

10. The method for producing an electrode catalyst for fuel cells according to claim 7, wherein said reducing agent is one or more agents selected from the group consisting of alcohols, formic acid, acetic acid, lactic acid, oxalic acid, hydrazine, and sodium borohydride.

11. The method for producing an electrode catalyst for fuel cells according to claim 8, wherein said reducing acid is one or more acids selected from the group consisting of formic acid, acetic acid, lactic acid, and oxalic acid.
